(19) United States
(12) Patent Application Publication
(10) Pub. No.: US 2002/0058536 A1
(43) Pub. Date: May 16, 2002

(54) Mobile phone

(76) Inventors: Youichi Horii, Kokubunji (JP); Yukinobu Maruyama, Kokubunji (JP); Takeshi Hoshino, Kodaira (JP); Daisuke Iseki, Tokyo (JP)

Correspondence Address: Mattingly, Stanger & Malur, P.C., Suite 370, 1800 Diagonal Road, Alexandria, VA, 22314, US

(21) Appl. No.: 09/919,911

(22) Filed: Aug. 2, 2001

(30) Foreign Application Priority Data
Nov. 10, 2000 (JP) 2000-349313

(51) Int. Cl. H04M 1/00

(52) U.S. Cl. 455/566; 455/575

(57) ABSTRACT

A mobile phone including a camera device and a main body. The camera device can communicate with the main body by a short-distance communication function. By using an image captured by the camera device, it is possible to support calling, mail passing, Internet connection, personal identification input. The camera device can be detached from the main body. Both of the camera device and the main body have short-distance wireless control modules, so that image information entered from the camera device can be transferred to the main body by the short-distance wireless communication and the transferred image is converted, for example, to text data which can be used as a phone number, Internet address, mail text, and the like to support a calling, Internet connection, mail passing, respectively.

### BACKGROUND OF THE INVENTION

1. Field of the Invention

The present invention relates to a mobile phone which processes image information fed from a camera.

For example, as is described in Japanese Patent Application 10-212022 (JP-A-2000-29988) (electronic camera and operation control method thereof), there has been suggested a method for cutting out a character string contained in an image obtained by an electronic camera and storing the character string into a storage medium such as a memory card.

Moreover, as is described in Japanese Patent Application 7-117292 (JP-A-8-116476) (recording apparatus having a video camera), a method is known for separating a VTR portion having a display and a camera portion so that a picture can be taken using a liquid crystal display of the VTR portion as an electronic view finder even when the camera portion is separated from the VTR portion.

According to the conventional method, a character string contained in an image taken by the camera is converted into text data, which is correlated with an image when stored, and has no relationship, for example, with communication by a mobile phone, mail, Internet connection, or face identification.

Moreover, in a recording apparatus having a video camera separated from a VTR portion, the camera portion is connected to the VTR portion via a cable, which may disturb operation.

### SUMMARY OF THE INVENTION

It is therefore an object of the present invention to provide a mobile phone facilitating operation by using an image taken by a camera for communication and mail through the mobile phone, Internet connection, face search, and the like.

It is another object of the present invention to provide a mobile phone enabling communication between a camera and an apparatus main body arranged at a short distance so as to improve the operation condition.

In order to achieve the aforementioned objects, a camera portion is made detachable from a main body and a short distance wireless communication control module is provided in both of them, so that image information fed from the camera portion is transferred to the main body by the short distance wireless communication and the transferred image is converted, for example into text data in an image processor arranged in the main body, so as to support as a phone number, an Internet address, mail text, and other information respectively for input of functions such as calling, Internet connection and mail.

### BRIEF DESCRIPTION OF THE DRAWINGS

FIGS. 1A to 1G show configuration of a mobile phone with a camera device according to an embodiment of the present invention.

FIGS. 2A to 2E show additional functions of the mobile phone with the camera device according to the embodiment of the present invention.

FIGS. 3A to 3E show a lock function of the mobile phone with the camera device according to the embodiment of the present invention.

FIG. 4 shows wired networking between cables of the mobile phone with the camera device according to the embodiment of the present invention,

FIGS. 5A to 5F show a symmetric shape of the mobile phone with the camera device according to the embodiment of the present invention.

FIGS. 6A and 6B show an operation example of the mobile phone with the camera device according to the embodiment of the present invention.

FIGS. 7A and 7B show a flow of the mobile phone with the camera device according to the embodiment of the present invention.

FIGS. 8A to 8C show phone number reading routine of the mobile phone with the camera device according to the embodiment of the present invention.

FIGS. 9A to 9D show an URL reading routine of the mobile phone with the camera device according to the embodiment of the present invention.

FIGS. 10A and 10B show a translation routine of the mobile phone with the camera device.

FIGS. 11A to 11C show a related information search routine of the mobile phone with the camera device according to the embodiment of the present invention.

FIGS. 12A to 12C show a handwritten memo reading routine of the mobile phone with the camera device according to the embodiment of the present invention.

FIGS. 13A to 13G show a key-image recognition routine of the mobile phone with the camera device.

FIGS. 14A to 14E show a face search routine of the mobile phone with the camera device according to the embodiment of the present invention.

### DETAILED DESCRIPTION OF THE EMBODIMENT

Description will now be directed to an embodiment of the present invention with reference to the attached drawings.

[1] Configuration of the Mobile Phone (with a Camera Device)

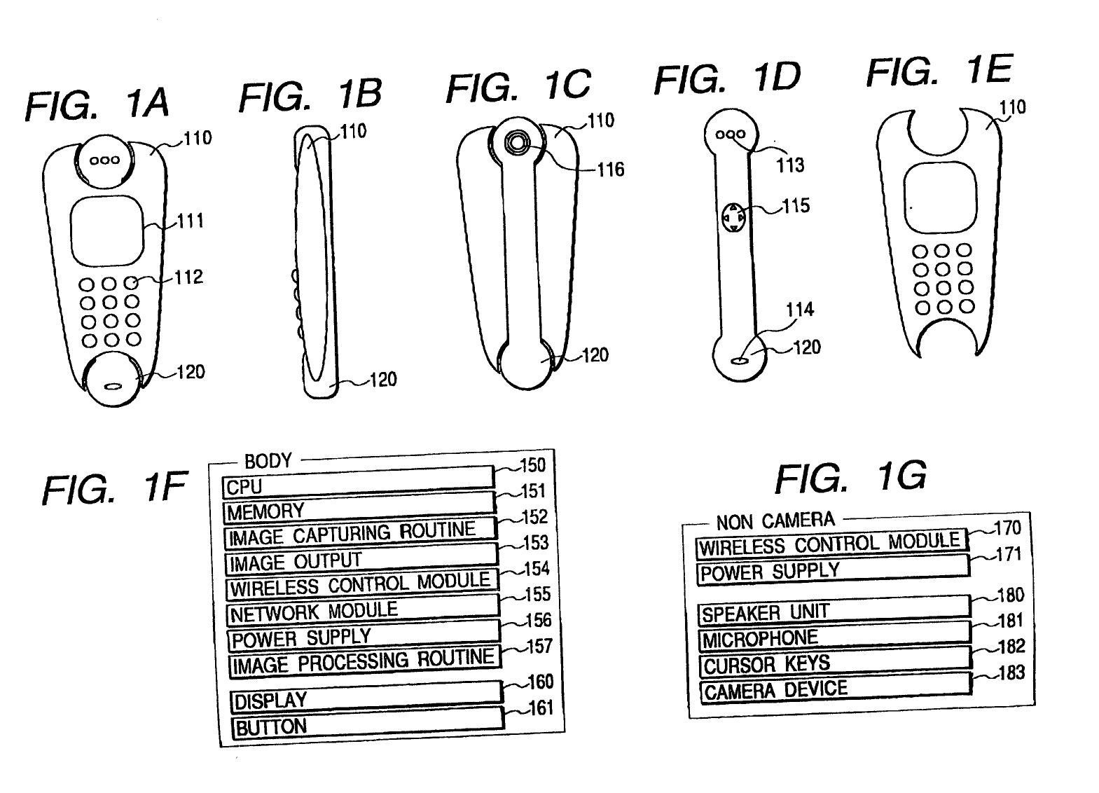

FIG. 1 shows configuration of the mobile phone with a camera device according to the present invention. FIG. 1A is a front view when the camera device is mounted on the main body; FIG. 1B is a side view; FIG. 1C is a rear view of the main body 110 and the camera device 120; FIG. 1D is a front view of the camera device; and FIG. 1E is a front view of the main body. The main body 111 includes a display and a set of buttons 112. for entering phone numbers and the like. The camera device 113 includes a speaker unit 113, a microphone 114, an up-down right-left cursor/enter button 115, and a camera 116 attached to the rear surface of the camera device.

FIG. 1F shows configuration of the main body. A CPU 150, a memory 151, an image in-take block 152, a video output block 153, a short-distance wireless control module 154, a network module 155, a power source 156 and an image processor 152 are provided inside the main body. The aforementioned display 160 and the button 161 are arranged on the front surface of the main body.

FIG. 1G shows configuration of the camera device. A short-distance wireless control module 170 and a power source 171 are provided inside the camera device. The aforementioned speaker unit 180, the microphone 181 and the cursor keys 182 are arranged on the front surface of the camera device and the camera 183 is arranged on the rear surface.

In the mobile phone with the camera according to the present invention, the camera device can be detached from the main body and can be operated in both cases when the camera device is mounted and when detached.

When the camera device is mounted on the main body, by using the button 112 and the display 111 of the main body and the speaker unit 113 and the microphone of the camera device, it is possible to perform calling, mail sending, and the Internet connection like in a normal mobile phone. Moreover, after taking a picture by using the camera 116 attached to the rear surface of the camera device, or after performing character recognition from an image taken in the image processor 157, it is possible to activate applications such as information search and translation.

When the camera device is detached from the main body, by using the cursor key of the camera device, it is possible to search a phone number from the phone number list stored in the memory 151 of the main body and perform calling from the speaker unit and the microphone of the camera device via the short-distance wireless control module 170 of the camera device and the short-distance wireless control module 154 of the main body. Moreover, via the short-distance wireless control modules of the camera device and the main body, an image taken by the camera 116 of the camera device is transferred to the memory 151 of the main body. For example, a picture can easily be taken by holding the main body with a user left hand and the camera device with his right hand.

[2] Additional Functions

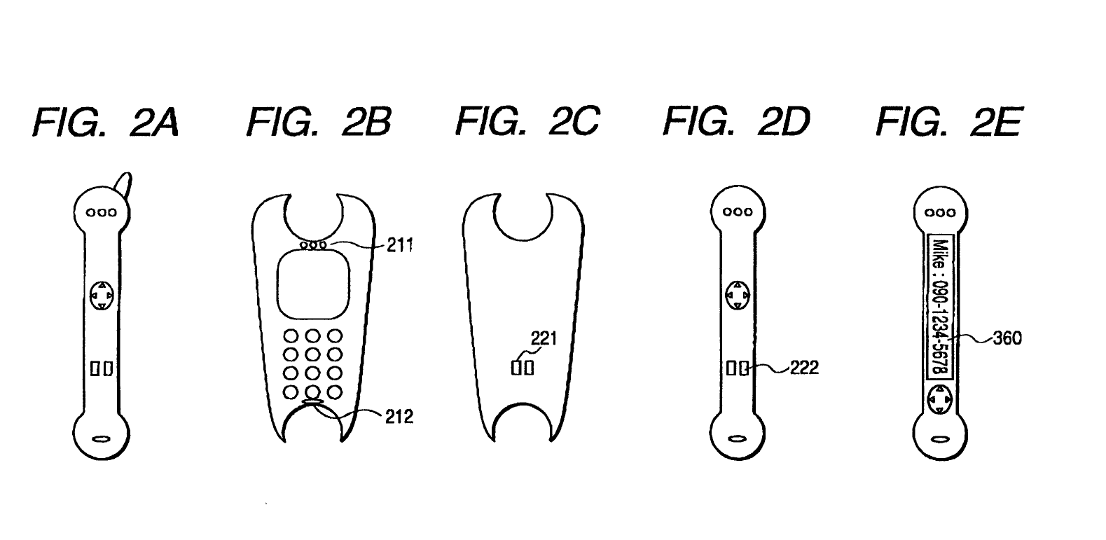

FIG. 2 shows additional functions that can be added to the mobile phone with the camera according to the present invention.

FIG. 2A shows an example in which an antenna 201 and a network module are added to the camera device of FIG. 1. By transferring the communication function from the main body to the camera device, it is possible to perform calling without placing the main body in the vicinity.

FIG. 2B shows an example in which a speaker unit 211 and a microphone 212 are added to the main body of FIG. 1, too.

FIG. 2C shows terminals (221 and 222) which are in contact with each other when the camera device is mounted on the main body. With these terminals through which current flows when the camera device is mounted on the main body, for example, it is possible to transfer power from the power source of the main body to the camera device, and when the camera device is detached from the main body, information can be passed through the terminals instead of a short-distance wireless communication, thereby saving the power consumption.

FIG. 2E shows an example in which a small-type display is attached to the camera device. In the camera device, for example, it becomes possible to easily search a phone number from the phone number list of the main body.

[3] Stopper Function

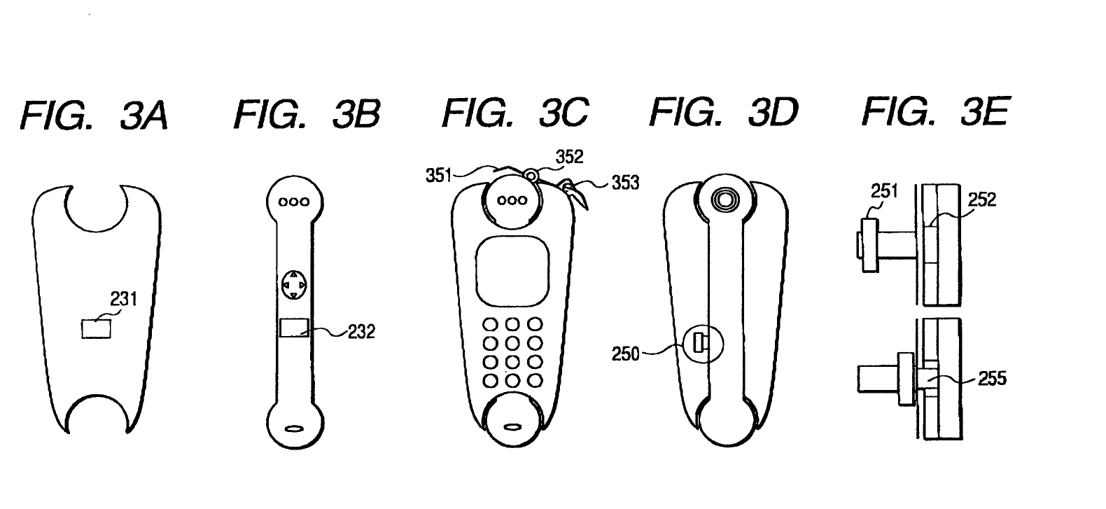

By referencing FIG. 3, explanation will be given on a function to prevent fall when the camera device is mounted on the main body in the aforementioned mobile phone with the camera according to the present invention.

FIG. 3A and FIG. 3B show an example in which a magnet or a magic tape is attached to the portions (231 and 232) which are brought into contact when the camera device is mounted on the main body.

FIG. 3C shows an example in which the main body and the camera device are both have holes (351 and 352) for passing a string-shaped strap 353 through.

FIG. 3D shows an example in which a wedge-shaped stopper 250 is provided. FIG. 3E shows it enlarged. The upper drawing in FIG. 3E shows a case when the camera device is detached and the lower drawing FIG. 3E shows a case when the camera device is mounted on the main body. The wedge-shaped stopper 255 in inserted via a portion 251 into the hole 252 of the camera device, thereby fixing the camera device to the main body. Moreover, a terminal as described with reference to FIG. 2C and FIG. 2D for power supply when the camera device is mounted on the main body is provided at the tip of the wedge 255 and at the depth of the hole 252, so as to perform signal transmission/reception between the camera device and the main body and charging as well.

[4] Wired Networking

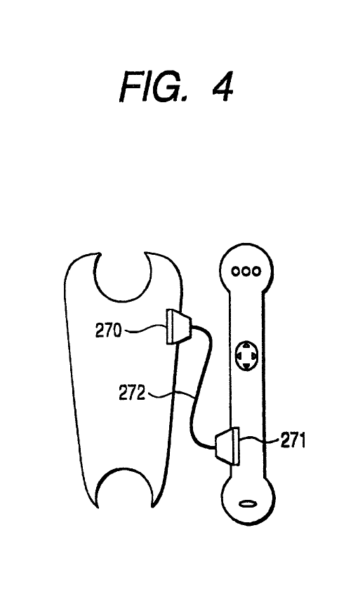

FIG. 4 shows wired networking using a cable for signal transmission/reception without using the short-distance wireless control modules in the mobile phone with the camera device according to the present invention described in FIG. 1. In general, wireless networking requires a large power consumption load and there is a problem that continuous use time is shortened when the power source is small. Accordingly, when no wireless networking is required, a communication cable 272 is used for connecting the signal line connection terminal 270 provided on the rear surface of the main body to the connection terminal 271 of the camera device, thereby performing signal transmission/reception via the wired networking, so as to save the power consumption.

[5] Symmetry

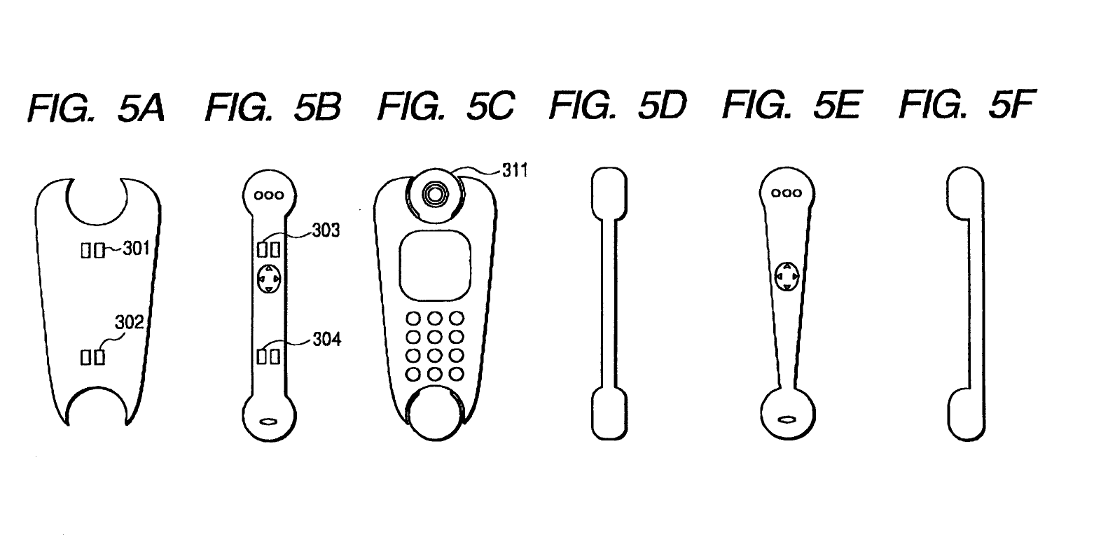

Referring to FIG. 5, explanation will be given on the symmetric shape when the camera device is mounted on the main body in the mobile phone with the camera device described with reference to FIG. 1.

FIG. 5A and FIG. 5B show the camera device which is symmetric in the up-down direction and can be mounted on the main body upside down. In this case, two pairs of connection terminals are arranged at the symmetric positions and it can be known whether the camera device is mounted in the correct direction or the reverse direction, thereby, for example, enabling signal incoming during the correct direction and disabling signal incoming during the reverse direction.

FIG. 5C shows a symmetric shape in the front-rear direction, so that the camera device can be mounted in the reverse direction, i.e., front-side at rear. FIG. 5D is a side view of the camera device having the symmetric shape in the front-rear direction. In this case also, similarly as the aforementioned, two pairs of connection terminals are arranged at the symmetric positions in the front-rear direction of the camera device, so as to control the state. Furthermore, when the camera device is mounted in the reverse direction, for example, it is possible to take a picture of (capture) a user himself/herself while looking at the display.

FIG. 5E shows an example of an asymmetric shape in the up-down direction unlike FIG. 5A and FIG. 5B, so that the camera device cannot be mounted on the main body in the reverse direction.

FIG. 5F shows an example of an asymmetric shape unlike FIG. 5F and FIG. 5D, so that the camera device cannot be mounted in the reverse direction.

[6] Operation Examples

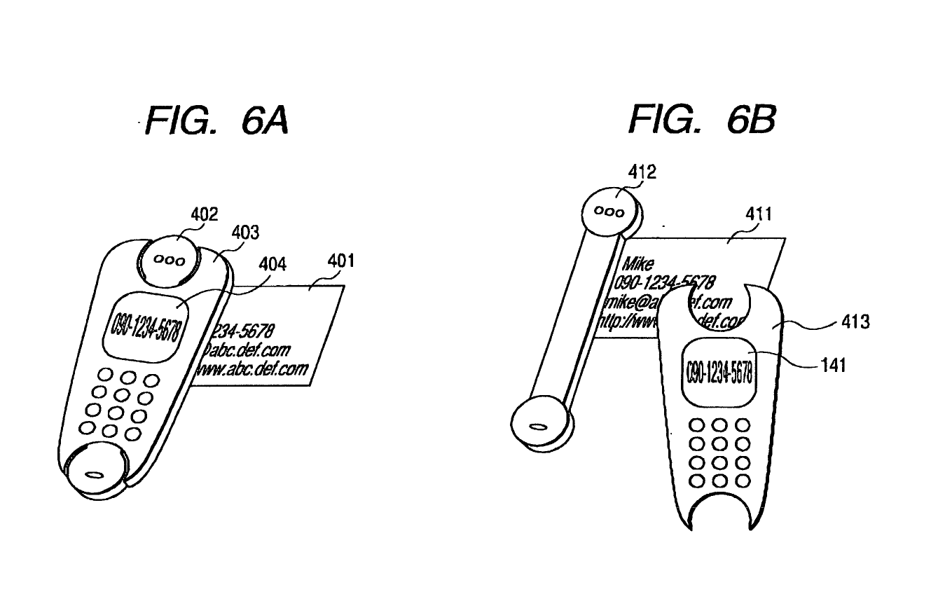

FIG. 6 shows an operation example of the mobile phone with the camera device according to the present invention described above with reference to FIG. 1.

FIG. 6A shows an operation example of the mobile phone with the camera device according to the present invention described above with reference to FIG. 1.

FIG. 6A shows an operation example when the camera device 402 is mounted on the main body. A sheet of paper 401 having a phone number list is captured and converted into phone number reading text data, so as to be displayed on the display 404 of the main body 403. This operation can be performed when the sheet of paper is in the vicinity of a user.

FIG. 6B shows a similar operation example when the camera device is detached from the main body. This operation is advantageous when a sheet of paper 411 having a phone number list is comparatively far from the user and it is difficult to confirm the picture taken by the camera using the display 414 of the main body 413. For example, the user can move the camera device to the vicinity of the sheet of paper using his/her left hand while holding the main body at a convenient position with his/her right hand, This improves operation procedure.

[7] Processing Flow

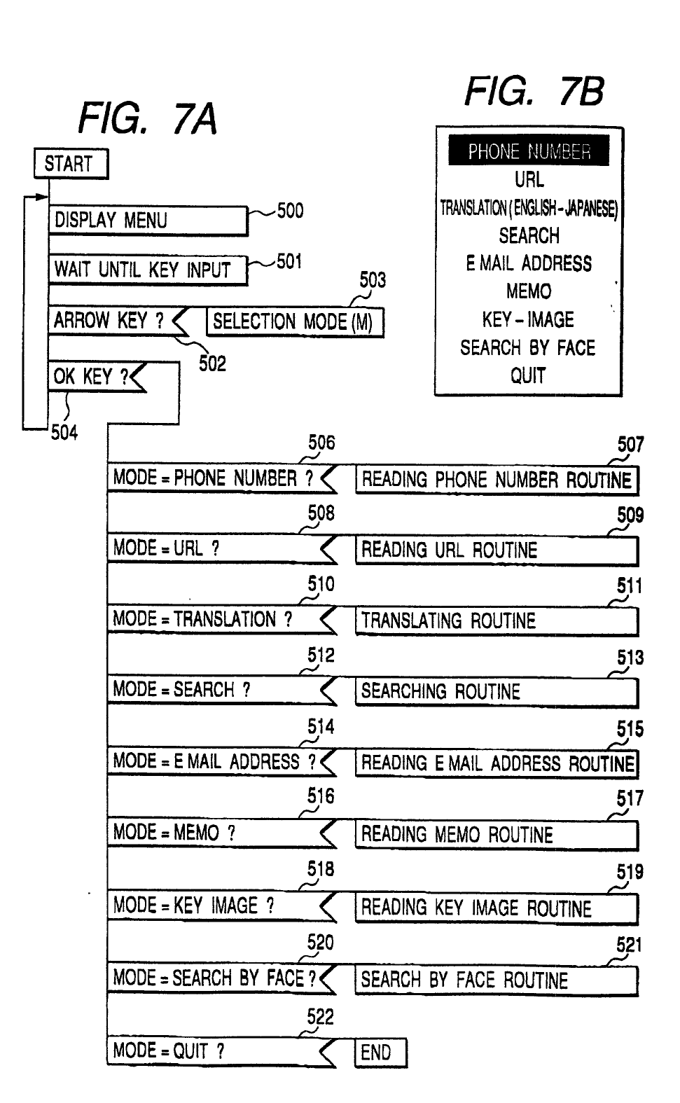

FIG. 7A shows a processing flow of the mobile phone with the camera device according to the present invention.

Firstly, in step 500, a function menu as shown in FIG. 7B is displayed. A white-black reversed mode represents a mode selected.

In steps 501, 502, and 503, the user operate the cursor key of the camera device up and down to select a particular mode.

In step 504, when the central portion (enter key) of the cursor key is pressed, control is passed to step 506 and after. Otherwise, control is returned to process 500.

When mode “phone number” is selected in step 506, a phone number reading routine (detailed later) is activated in step 507.

When mode “URL” is selected in step 508, an ULR reading routine (detailed later) is activated in step 509.

When a “translation” mode is selected in step 510, a translation routine (detailed later) is activated.

When a “related information search” mode is selected in step 512, a related information search routine (detailed later with reference to FIG. 11) is activated in step 513.

When a “mail address” mode is selected in step 514, a mail address read routine is activated in step 515.

When a “memo input” mode is selected in step 516, a handwritten memo reading routine (detailed later with reference to FIG. 12) is activated in step 517.

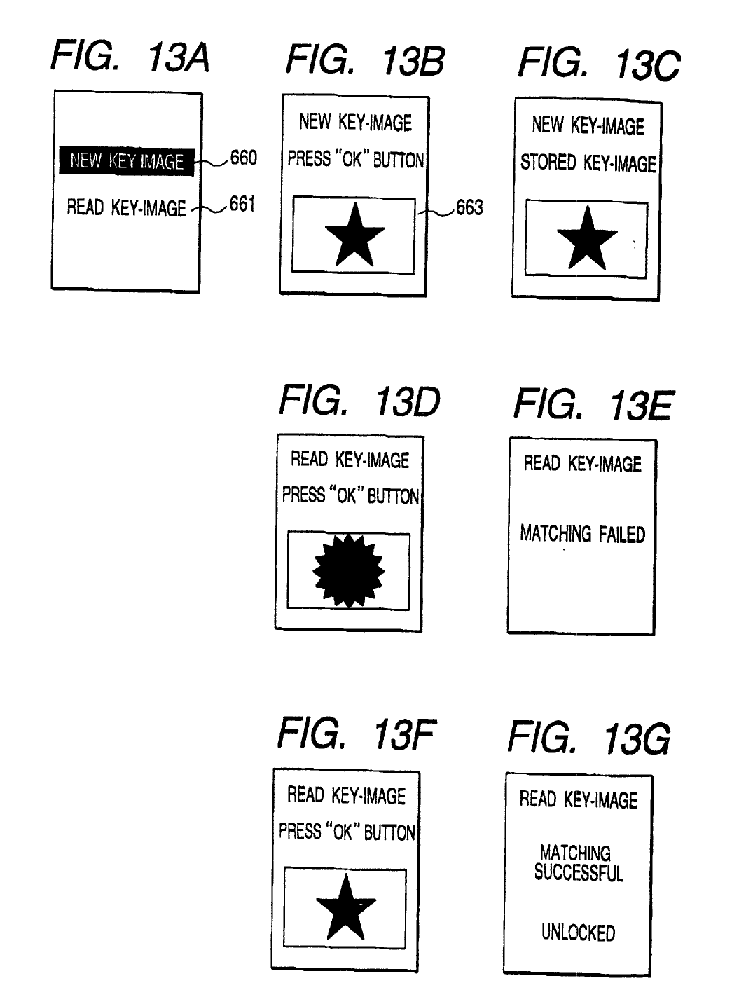

When a “key image” mode is selected in step 518, a key image recognition routine (detailed later with reference to FIG. 13) is activated in step 519.

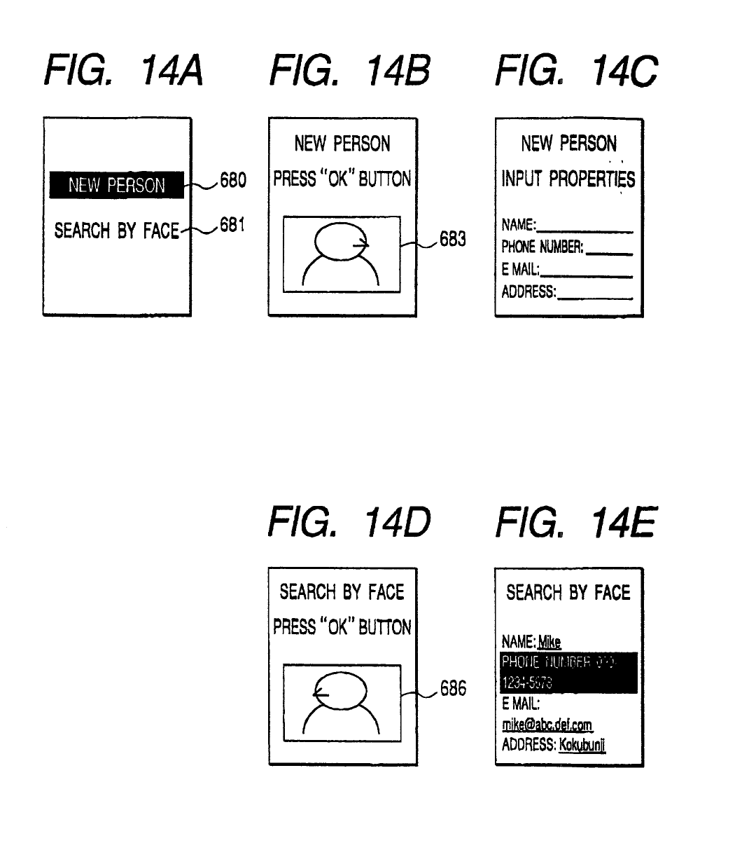

When an “person search” mode is selected in step 520, a person search routine (detailed later with reference to FIG. 14) is activated in step 521.

When a “quit” mode is selected, the processing is terminated.

[8] Phone Number Reading Routine

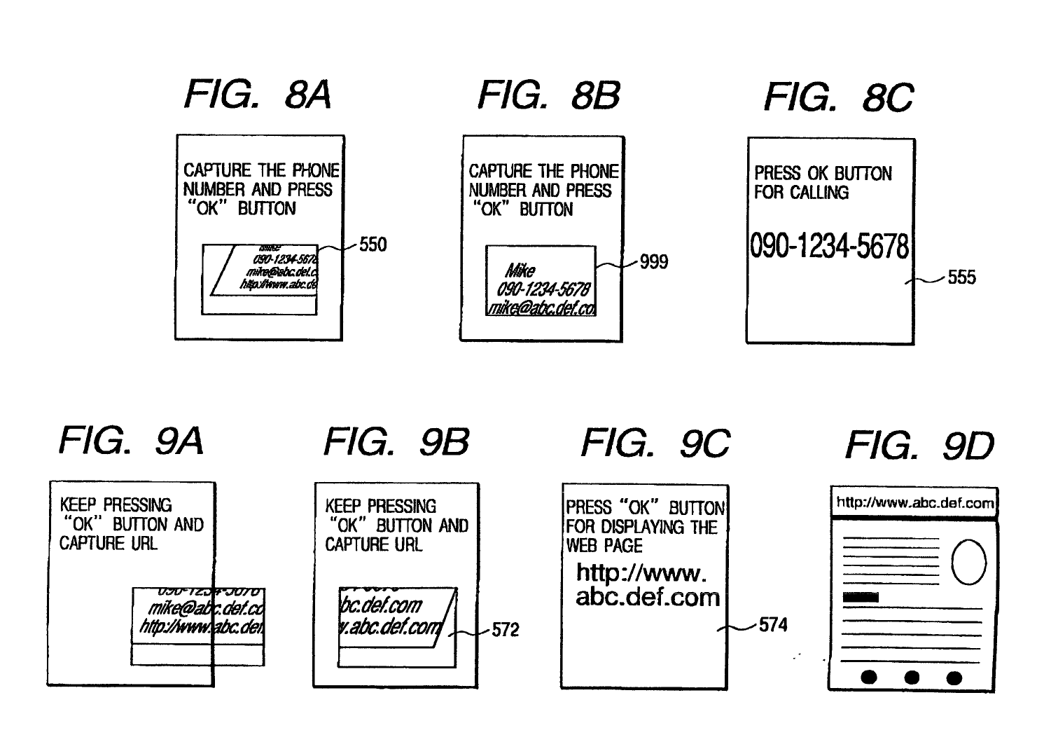

By referring to FIG. 8, explanation will be given on the phone number reading routine.

FIG. 8 shows images appearing on the display when the phone number reading routine is activated.

Firstly, as shown in 550 of FIG. 8A, an image entered from the camera device is displayed on the display screen and when phone numbers are captured, the enter button (OK button) is pressed.

FIG. 8B shows an image immediately before pressing the enter button.

FIG. 8C shows characters cut out of the image read in and a phone number portion is recognized, which is converted into font data to display 555. After this, the enter button is pressed, thereby calling the recognized phone number.

[9] URL Reading Routine

Referring to FIG. 9, explanation will be given on the URL reading routine. FIG. 9 shows images displayed when the URL reading routine is activated.

Firstly, as shown in 570 of FIG. 9A to 572 of FIG. 9B the enter button is continuously pressed to take a picture of the URL from head to the bottom by the camera device. When the enter button is released, the taking picture is terminated. In general a character string describing an URL is long in the horizontal direction, a plurality of images are taken in and synthesized into an image of high resolution, thereby improving the character recognition accuracy.

FIG. 9C shows an example of font data converted from the characters recognized, so as to display an URL 574. If the enter button is further pressed in this state, as shown in FIG. 9D, a page of the recognized URL is displayed. Moreover, the downward arrow of the cursor key is pressed to store the URL in the memory.

[10] Translation Routine

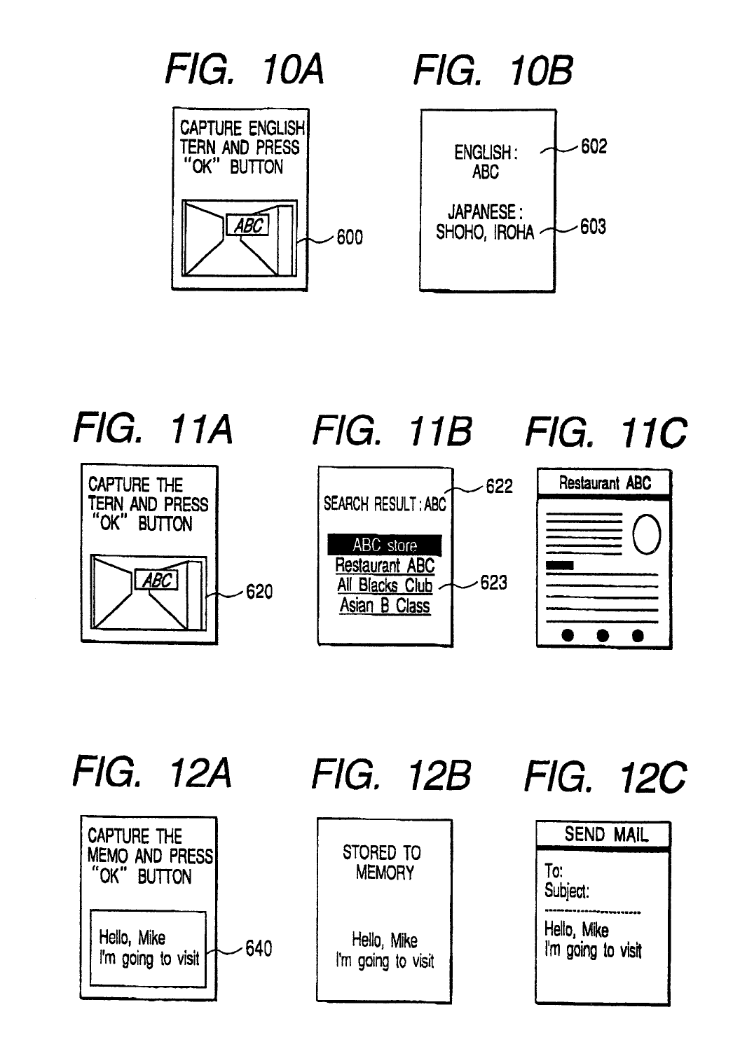

Referring to FIG. 10, the translation routine will be explained. FIG. 10 shows images displayed when the translation routine is activated.

Firstly, as shown in FIG. 10A, an image entered from the camera device is displayed as 600 and when a character string to be translated is captured, the enter button is pressed. When the enter button is pressed, characters contained in the captured image are extracted and converted into text data by a character recognition algorithm. Furthermore, a translated word corresponding to the text data is searched.

Next, as shown in FIG. 10B the text data 602 recognized as the characters and the corresponding term 603 are displayed on the display screen.

[11] Related information search routine Referring to FIG. 11, explanation will be given on the related information search routine. FIG. 11 shows screen images displayed when the related information search routine.

Firstly, as shown in FIG. 11A, an image input from the camera is displayed as shown by 620 and when a character string to be searched is displayed, the enter button is pressed. When the enter button is pressed, characters contained in the captured image are extracted and converted into text data by the character recognition algorithm. Furthermore, related information for the text data as a keyword is searched using a database in memory or the Internet search engine, so as to create a related information list.

Next, as shown in FIG. 11B, the text data 622 after the character recognition and the related information list 623 are displayed on the screen. Here, an item to be read is selected from the related information list by using the up-down key of the cursor button and the OK (enter) button is pressed, so as to display a detailed database or Internet home page (FIG. 11C).

[12] Handwritten Memo Reading Routine

Referring to FIG. 12, explanation will be given on the handwritten memo reading routine. FIG. 12 shows an example of images displayed on the screen when the handwritten memo reading routine is activated.

Firstly, as shown in FIG. 12A, an image entered from the camera is displayed as 640 on the screen and when the handwritten memo to be read is captured, a user press the enter button. When the enter button is pressed, characters contained in the image are extracted and converted into text data by the character recognition algorithm. Furthermore, the text data is stored in the memory and a confirmation image is displayed on the screen as shown in FIG. 12B. The handwritten memo can later be transferred to a calculator or used as a text or title of a mail as shown in FIG. 12C.

[13] Key-image Recognition Routine

Referring to FIG. 13, explanation will be given on the key-image recognition routine. FIG. 13 shows an example of images displayed on the screen when the key-image recognition routine is activated. The key-image represents an image to be used as a password so as to protect the mobile phone, i.e., the mobile phone cannot be used by a person other than the user.

Firstly, as shown in FIG. 13A, a keyimage loading 660 or key-image recognition 661 is selected When a key-image loading is selected, as shown in FIG. 13B, an image entered from the camera is displayed as shown by 663 on the screen and when a desired image is captured, the user presses the enter button. The image entered is stored in the memory and The an image for confirming the loading is displayed on The screen (FIG. 13C), so as to be used for the next key-image recognition.

When the key-image recognition is selected, for example, when an image different from the loaded image is entered (FIG. 13D), as shown in FIG. 13E, a message indicating miss-match is displayed. on the other hand, when a correct image is entered (FIG. 13F), as shown in FIG. 13G, a message indicating a successful matching and, for example, an unauthorized use protection is released.

[14] Face Search Routine

Referring to FIG. 14, explanation will be given on the face search routine. FIG. 14 shows an example of images displayed when the face search routine is activated.

Firstly, as shown in FIG. 14A, the user selects whether to load a person through his/her face (680) or search a person through his/her face (681) When the person loading is selected, as shown in FIG. 14B, an image entered from the camera is displayed (683) on the screen and when a desired person is captured, the user presses the enter button.

Next, as shown in FIG. 14C, the user enters various information such as a personal name, phone number, e-mail address, and a geographical address so as to be stored together with the captured image.

Moreover, when the person search is selected, as shown in FIG. 14D, an image entered from the camera is displayed (686) on the screen and when a desired person is captured, the user presses the enter button. an image identification is performed using the image information of the persons stored in the memory and as shown in FIG. 14E, corresponding personal information is displayed on the screen.

According to the present invention, it is possible to place the main body having the display screen at a place where the user can easily see the screen and move the camera device to the vicinity of an object to be captured, thereby easily take a picture of the object while confirming an image on the display screen. Moreover, by converting a captured image, for example, into text data to be used as a phone number, Internet address, mail text, and other information, it is possible to easily use the calling function, the Internet connection, mail transmission, and other functions.

What is claimed is:

1. A mobile phone comprising a main body having a telephone function and a camera device having a camera and means for transferring images captured by the camera device to the main body by a short-distance wireless connection, wherein the images are processed either in the camera device or in the main body.

2. The mobile phone as claimed in claim 1, wherein the camera device has a speaker unit and a microphone and can communicate with the main body having the telephone function by the short-distance wireless communication, thereby enabling to perform a calling only with the camera device.

3. The mobile phone as claimed in claim 1, wherein the camera device has a speaker unit, a microphone, and a telephone functions, and can communicate with the main body provided with a telephone number list, thereby enabling to perform a calling only with the camera device.

4. The mobile phone as claimed in claim 1, wherein each of the camera device and the main body has a speaker unit and a microphone, so that calling can be performed with the main body when the camera device is mounted on the main body and when the camera device is detached from the main body.

5. The mobile phone as claimed in claim 1, wherein terminals are arranged at a contact portion between the camera device and the main body when the camera device is mounted on the main body, so that power can be supplied from a power source in the main body to the camera device.

6. The mobile phone as claimed in claim 1, wherein terminals are arranged at a contact portion between the camera device and the main body when the camera device is mounted on the main body, so that power can be supplied from a power source in the camera device to the main body.

7. The mobile phone as claimed in claim 1, wherein terminals are arranged a contact portion between the camera device and the main body when the camera device is mounted on the main body, so that signal transmission/reception can be performed through a cable without using the short-distance wireless communication.

8. The mobile phone as claimed in claim 1, wherein the camera device has a liquid crystal screen and telephone number list information in the main body can be displayed on the liquid crystal screen.

9. The mobile phone as claimed in claim 1, wherein a stopper is provided to prevent falling of the camera device from the main body when the camera device is mounted on the main body.

10. The mobile phone as claimed in claim 9, wherein a magnet is arranged at a contact portion between the camera device and the main body when the camera device is mounted on the main body.

11. The mobile phone as claimed in claim 9, wherein a magic tape is arranged at a contact portion between the camera device and the main body when the camera device is mounted on the main body.

12. The mobile phone as claimed in claim 9, wherein a wedge-shaped slide-type stopper is provided for fixing the camera device to the main body when the camera device is mounted on the main body.

13. The mobile phone as claimed in claim 9, wherein each of the main body and the camera device has an opening hole.

14. The mobile phone as claimed in claim 1, wherein a terminal is provided fir detecting mounted/detached states of the camera device at the main body.

15. The mobile phone as claimed in claim 1, wherein a cable connection terminal is provided on each of the main body and the camera device, so that signal transmission/reception can be performed through a cable when the camera device is detached from the main body.

16. The mobile phone as claimed in claim 1, wherein the camera device has a switch to replace the button operation on the main body.

17. The mobile phone as claimed in claim 16, wherein the camera device has a cursor key to replace the button operation on the main body.

18. The mobile phone as claimed in claim 1, wherein the camera device has a symmetric shape in the vertical (up-down) direction.

19. The mobile phone as claimed in claim 18, wherein a terminal is provided for detecting whether the camera device is mounted in a correct direction (up-down) or a reverse direction.

20. The mobile phone as claimed in claim 18, the mobile phone further comprising means for detecting whether the camera device is mounted on the main body in a correct direction or a reverse direction, so that the control method of the main body is switched from one to the other according to the detected direction.

21. The mobile phone as claimed in claim 1, wherein the camera device has a symmetric shape in the front-rear direction.

22. The mobile phone as claimed in claim 1, wherein the camera device has an asymmetric shape in the vertical (up-down) direction.

23. The mobile phone as claimed in claim 1, wherein the camera device as an asymmetric shape in the front-rear direction.

24. A mobile phone comprising a camera device and a main body in such a way that the camera device can be detached from the main body and furthermore, means is provided for transferring an image captured by the camera device to the main body by a short-distance wireless communication, so that the image is subjected to a pattern recognition processing in the camera device or in the main body, so as to be converted into text information, which is used for information processing.

25. The mobile phone as claimed in claim 24, wherein text information of a numeric string converted is used as a telephone number and a call is performed.

26. The mobile phone as claimed in claim 24, wherein the converted text information is used as as an Internet address and Internet connection is performed.

27. The mobile phone as claimed in claim 24, wherein the converted text information is translated to another language and the result is displayed on the screen.

28. The mobile phone as claimed in claim 24, wherein the converted text information is translated into another language and the translation result is displayed on the screen.

29. The mobile phone as claimed in claim 24, wherein the converted text information is used as a mail address so as to utilized for mail transmission.

30. The mobile phone as claimed in claim 24, wherein the converted text information is used as a mail text so as to be utilized for mail transmission.

31. The mobile phone as claimed in claim 24, wherein according to the function using recognized characters, the object character type is switched from one to another, thereby improving the character recognition accuracy.

32. A mobile phone comprising a camera device and a main body in such a way that the camera device can be detached from the main body and furthermore, means is provided for transferring an image captured by the camera device to the main body by a short-distance wireless communication, so that the image is subjected to a pattern recognition processing in the camera device or in the main body, so as to be converted into properties information, which is used for information processing.

33. The mobile phone as claimed in claim 32, wherein a user face is captured from the camera device and subjected to a pattern recognition processing, so as to be converted into properties information, which is used to set and release the mobile phone locking, thereby preventing an unauthorized use of the mobile phone.

34. The mobile phone as claimed in claim 32, wherein a person image is captured from the camera device and subjected to a pattern recognition processing, so as to be converted into properties information, which is loaded in relation with personal information such as a telephone number, e-mail address, and a geographical address, so that when the person image is again captured, the image is subjected to the pattern recognition processing, so as to be converted into properties information for searching the personal information.

35. A mobile phone comprising a first terminal having a camera and a second terminal having a ten-key set, wherein the first terminal and the second terminal includes: an electric terminal for use for passing data captured by the camera when the first terminal is physically connected to the second terminal into a unit; and short-distance wireless communication means for passing data captured by the camera when the first terminal is physically detached from the second terminal.
